(19) United States
(12) Patent Application Publication
(10) Pub. No.: US 2013/0090911 A1
(43) Pub. Date: Apr. 11, 2013

(54) Modeling Test Space for System Behavior Using Interchangeable Designations

(71) Applicants: Itai Segall, Tel-Aviv (IL); Rachel Tzoref-Brill, Haifa (IL); Aviad Zlotnick, Tel mond (IL)

(72) Inventors: Itai Segall, Tel-Aviv (IL); Rachel Tzoref-Brill, Haifa (IL); Aviad Zlotnick, Tel mond (IL)

(73) Assignee: International Business Machines Corporation, Armonk, NY (US)

(21) Appl. No.: 13/253,084

(22) Filed: Oct. 5, 2011

(51) Int. Cl. G06F 9/44; G06F 17/00

(52) U.S. Cl. 703/21

(57) ABSTRACT

A method for modeling test space for verifying system behavior is provided. The method comprises defining a coverage model based on one or more variables, wherein respective value combinations for the variables are assigned to define a test space for a system under test, and zero or more constraints define restrictions on value combinations assigned to the variables, wherein the restrictions define whether said value combinations are valid; and designating, as interchangeable, relevant variables values in the coverage model.

### COPYRIGHT & TRADEMARK NOTICES

A portion of the disclosure of this document may contain material subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to modeling test space for testing system behavior.

### BACKGROUND

Model based techniques may be used for generating tests for verifying the behavior of a computing system. Traditionally, a model includes a set of attributes in addition to values for the attributes and corresponding restrictions on said values or value combinations. The set of valid value combinations defines the space to be tested. In a test design that is based on Cartesian product modeling, the test space is selected so that it covers all possible combinations of n number of variables that are not ruled out by restrictions.

The size of a Cartesian product based model is the product of the number of values for each attribute (i.e., A₁*A₂*. . . *Aₙ), where Aₙ represents the number of valid values for the n^{th} attribute. One would appreciate that the size of the model can become prohibitively large, depending on the number of attributes, the possible number of values assigned to each attribute and the restrictions used to define complex attribute relationships.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for modeling test space for verifying system behavior is provided. The method comprises defining a coverage model based on one or more variables, wherein values for the variables are assigned to define a test space for a system under test, and zero or more constraints define restrictions on value combinations assigned to the variables, wherein the restrictions define whether said value combinations are valid; and designating, as interchangeable, relevant variables values in the coverage model.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 is a flow diagram of an exemplary method for modeling a test space for system behavior, using interchangeable elements, in accordance with one embodiment.

FIG. 2A illustrates an exemplary computing environment in accordance with one or more embodiments, wherein a coverage model is implemented for verifying a computing system.

FIGS. 2B and 2C are exemplary illustrations of the possible interchangeable value combinations for variables defined for an example model, according to one or more embodiments.

FIGS. 3A and 3B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one or more embodiments, a coverage model is implemented to test a target system. The model defines variables (i.e., attributes), possible values for the variables, and conditions or restrictions indicating when values for one or more variables or value combinations for a plurality of variables are valid or invalid. The set of valid value combinations defines the coverage model. The test space may be defined by the product (e.g., the Cartesian product) of variable values, taking into account the dictated conditions or restrictions. The size of the test space is roughly proportional to the product of the number of values that can be assigned to each variable.

In one implementation, complexity associated with verification of the test space may be reduced by, for example, narrowing the test space by way of defining additional test coverage conditions, restrictions or requirements. In one embodiment, the test space may be reduced by relaxing the requirement to cover all the combinations of all the variables to a requirement to cover a selected subset of the Cartesian product. For example, given a Cartesian product based model with n variables, a combinatorial algorithm may be used to find a subset of valid combinations in the test space that covers possible combinations of every m variables, wherein m defines a certain interaction level.

The interaction level, depending on implementation, refers to the coverage of the selected subset of the test space, wherein the test space covers the possible combinations of m number of variables in the set defined by the respective coverage model—m is less than or equal to the total number of variables n in the model. As an example, interaction level two (also referred to as a pair-wise interaction) means that, for every two variables, all valid value combinations appear in the selected subset of the test space. The motivation for this approach is that empiric evidence shows that most bugs depend on the interactions between a small number of variables. And that, in general, testing such interactions leads to detecting a majority of bugs in a system.

Depending on implementation, the interaction level requirements may be defined at multiple levels with mixed-strength. For example, interaction level m may be defined for one subset of variables, and interaction level k for another subset of variables. In one embodiment, the two subsets of variables are not disjoint but may include mutually inclusive members depending on the test coverage goals and limitations. This will allow a test developer with flexibility in defining a test space that covers certain variables or values with more particularity.

In one embodiment, the combinatorial algorithm utilized to provide an m-way combination of values may be iterative in nature. In an iteration, the algorithm may find a valid set of values for the target variables such that the found set contributes the most to the remaining uncovered combinations. After applying the combinatorial algorithm to the coverage model with an interaction level m, the resulting test plan may include all valid value tuples of size m. In one implementation, the test planning scheme may be configured to determine whether the resulting test plan includes redundancies. Such redundancies may exist where, for example, interchangeable elements (e.g., multiple instances of the same type or category of variables or symmetric interactions) are present.

For the purpose of example, consider a model that includes variables that cover: two hosts, two switches, and two storage controller variables. The two hosts may be deemed interchangeable, if the two hosts interact with other variables in the same manner, with respect to the aspect being tested. In an analogous manner, within the context of the example provided here, it may also be determined that the two switches are interchangeable, or that the two storage controllers are interchangeable, for example.

In a scenario where the objective of the model is to test pair-wise interactions between the test elements, e.g., (host, switch), (host, storage), (switch, storage), (host, host), (switch, switch) and (storage, storage), the number of pair-wise interactions to be tested may be reduced based on the recognized interchangeability between the test elements—it is worthy to reiterate that in other example implementations, certain embodiments may be implemented with m-way interactions.

In the above example, whether the corresponding common tested value is in the first or the second variable of the interchangeable pair of variables may not be important. That is, for coverage purposes, it would be sufficient to test a single host to switch relationship for each pair of values (e.g., host1=x, switch1=y). In addition, it would be sufficient to test the interactions between the two hosts without regard to the internal order of the relationship (e.g., if (host1=x, host2=y is tested then it is not needed to test (host1=y, host2=x)).

Accordingly, in the above scenario, a complete coverage of the possible combinations for host1, host2, switch1, switch2 based on a pair-wise interaction level would require four separate tests, i.e., (host1=x, switch1=y), (host2=x, switch1=y), (host1=x, switch2=y), (host2=x, switch2=y). Recognizing the redundancies present in the model, the same level of coverage may be accomplished by performing a single test (e.g., host1=x, switch1=y) instead of all four.

Accordingly, in one or more embodiments, the coverage model is implemented to recognize interchangeable elements of a system under test. Interchangeable elements may reflect symmetry, internal order neutrality or other categorization that may be used to define or designate a division of valid value tuples into equivalence classes. As provided in further detail below, one or more representatives of each equivalent class may be covered by the test plan to allow for modeling the system in a natural way, and to generate an optimized test plan that does not contain redundancy resulting from the interchangeable elements.

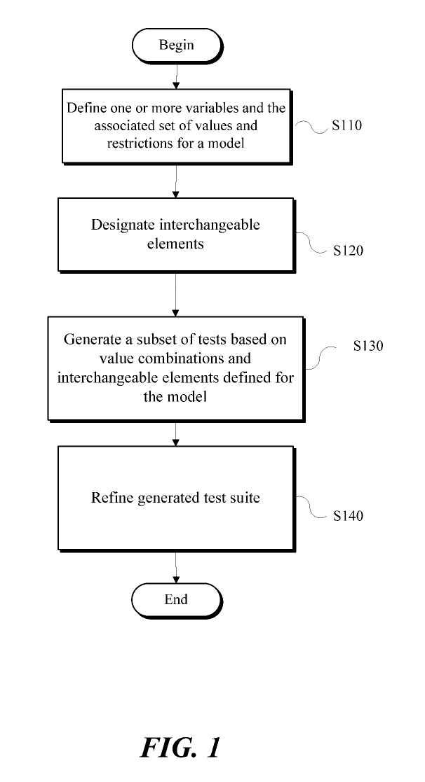

Referring to FIG. 1, in one embodiment, a test suite having a plurality of test is defined based on one or more variables and the associated set of variable values in addition to conditions that define restrictions on said values or combinations of values that may be assigned to those variables (S110). The plurality of tests may be randomly generated, augment an existing set of tests or selected from an existing set of tests. In one implementation, a test designer is provided with the option to reduce the test plan generated based on the coverage model by designating interchangeable elements (S120). As provided earlier, a combinatorial algorithm may be used to define a subset of tests based on the set of value combinations and interaction levels defined, taking into account the interchangeable elements (S130).

In one embodiment, the designation of interchangeable elements may be accomplished by configuring the combinatorial algorithm to accept as input declarations that identify the interchangeable elements for one or more coverage requirements. It is noteworthy that depending on implementation, the order in which processes defined in S120 and S130 are performed may be reversed. That is, the combinatorial algorithm may be applied to the model before the interchangeable elements are defined. Interchangeability may also be defined before S110, for example, by stating up front that any two values that are the same are interchangeable.

The above-noted arrangement for defining the interchangeable elements after applying the combinatorial algorithm, however, may not be conducive to the most optimal or efficient test strategy for the reasons discussed in further detail below. Regardless, the generated test suite is refined taking into account the interchangeable elements and the designated value combinations and interaction levels for the variables (S140).

For the purpose of providing a clarifying illustration and referring back to the example provided earlier for the model having two hosts, two switches, and two storage controller variables, the coverage requirements may be designated as provided below—programming declarations may be used to identify interchangeable variables, interchangeable values of a variable, or any other combinations thereof from which a division of the value tuples into equivalent classes may be derived.

cover every two of ({host1, host2}, {switch1, switch2},
{storage1, storage2})
cover every two of ({host1, host2})
cover every two of ({switch1, switch2})
cover every two of ({storage1, storage2})

In the above example, the syntax used for a set of variables inside curly brackets indicates that the set is interchangeable. The first requirement in the example indicates that in every pair of (host, switch), (switch, storage) and (host, storage), it doesn't matter if the first or second host, switch or storage is covered. The last three requirements indicate that the internal order between the two hosts or switches or storage controllers doesn't matter. In an alternate scenario, if the internal order does matter, no interchangeable elements will be declared in the last three requirements, thus requesting full coverage of the identical pairs of values.

In one embodiment, support for interchangeable elements in the combinatorial algorithm may be provided by considering the interchangeable elements while generating the test suite for a model and then removing from the model the tests (e.g., combinations of variable values) that cover redundant value tuples (i.e., tuples that are interchangeable with tuples that appear in other tests). This approach, depending on implementation, may result in a small reduction in the size of the test suite. However, since tests that include redundant tuples are likely to also include non-redundant tuples, such tests may not be removed from the test suite.

In another embodiment, support for interchangeable elements in the combinatorial algorithm may be provided by updating the coverage requirements in real time (i.e., on-the-fly) as the test suite is being constructed. That is, once a test is added to the test suite by the combinatorial algorithm, the coverage requirements is updated so that for each tuple in the added test, the equivalent tuples are no longer required to be considered for coverage. Using this real time updating approach, the combinatorial algorithm is configured to generate an optimized test plan that does not aim at covering the redundant tuples.

Interchangeable elements, in one embodiment, may be designated by inference rules. An inference rule is a rule that states, given a test, what coverage requirements are covered. The coverage inference rules depending on implementation may be of the form: if a1==v and a2==w then cover (a1=v, a2=w), where v and w are symbolic, and are bound to values given a test. The interchangeable elements in the example above may be specified by exemplary inference rules provided below:

if host1==h1 and OS1==o1 then cover {(host1=h1,
OS1=o1), (host2=h1, OS1=o1), (host1=h1, OS2=o1),
(host2=h1, OS2=o1)}
if host2==h1 and OS1==o1 then cover {(host1=h1,
OS1=o1), (host2=h1, OS1=o1), (host1=h1, OS2=o1),
(host2=h1, OS2=o1)}
if host1==h1 and OS2==o1 then cover {(host1=h1,
OS1=o1), (host2=h1, OS1=o1), (host1=h1, OS2=o1),
(host2=h1, OS2=o1)}
if host2==h1 and OS2==o1 then cover {(host1=h1,
OS1=o1), (host2=h1, OS1=o1), (host1=h1, OS2=o1),
(host2=h1, OS2=o1)}

Note that using inference rules, one can specify not only equivalent relations between value tuples, but also directional (i.e., one-way) interchangeability. For example, if the first two rules in the example above are specified, then the combinations (host1, OS2) and (host2, OS2) are interchangeable with (host1, OS1) and (host2, OS1). However, in the other direction, no interchangeability between the same elements may be designated.

In one embodiment, elements of the model (e.g., the variables or values) that are candidates for interchangeability are automatically detected. Interchangeable variables candidates may be detected by finding pairs of variables (e.g., var1 and var2) with common values so that for each pair of values (x,y), a test where var1=x and var2=y is legal, if and only if the same test with var1=y and var2=x is legal.

The automatic detection scheme provided above may be further applied to find multiple pairs of interchangeable variables at once and to find sets of interchangeable variables. Interchangeable values candidates may be detected by finding pairs of values (x,y) of a variable var1 so that a test where var1=x is valid, if and only if the same test with var1=y is valid. This definition may be extended to sets of values in one or more embodiments.

For the purpose of providing a full disclosure, another example applying the methods discussed above is provided below. It is noteworthy, however, that the provided example below is based on one of many possible implementations and embodiments. And that the details disclosed in this example are not to be used to narrowly construe the scope of the claimed subject matter or as limited to the disclosed details or features.

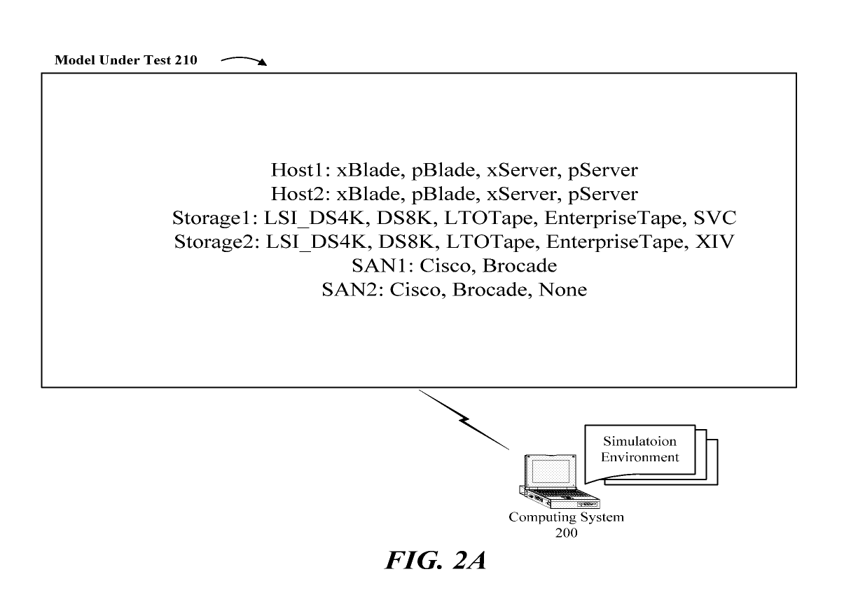

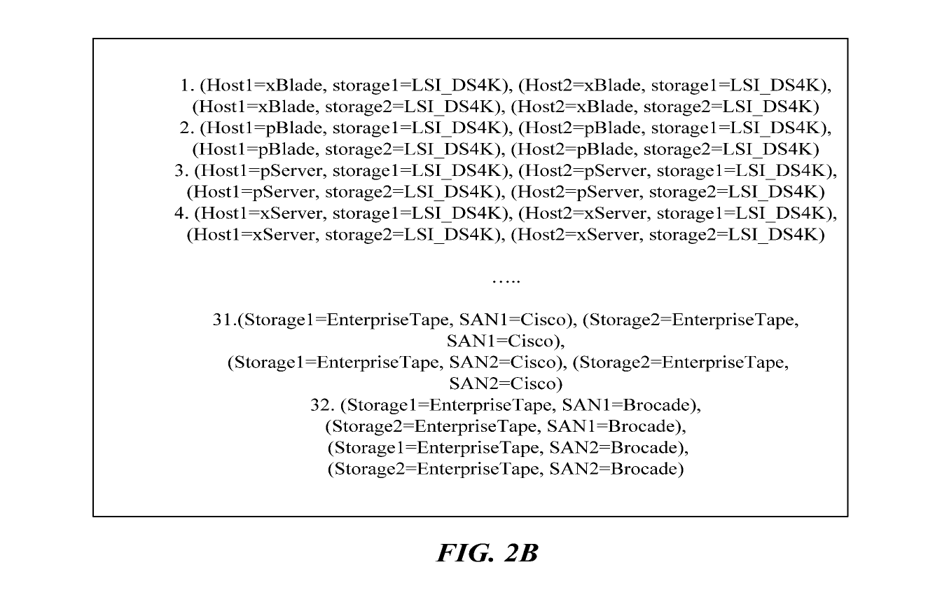

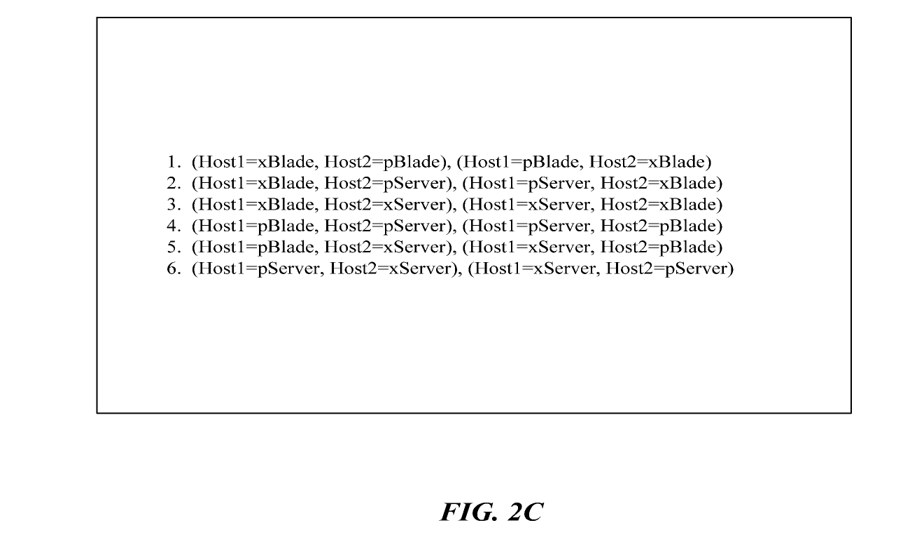

Referring to FIG. 2A, for example, a model under test 110 may be provided in a simulation (or non-simulation) environment constructed over computing system 110 to test the functionality of the model. A plurality of sets may be defined where each member of the set represents a test value for a variable represented by that set. In an example scenario involving six variables, the following presentation of possible values may be provided for variables Host1, Host2, Storage1, Storage2, SAN1, SAN2:

Host1: xBlade, pBlade, xServer, pServer
Host2: xBlade, pBlade, xServer, pServer
Storage1: LSI_DS4K, DS8K, LTOTape, EnterpriseTape, SVC
Storage2: LSI_DS4K, DS8K, LTOTape, EnterpriseTape, XIV
SAN1: Model1, Model2
SAN2: Model1, Model2, None

In this example, the test plan is to cover all pairs of any host with any storage, any storage with any SAN, and any host with any SAN. In the requested pairs to be covered in this context, it is immaterial from which host or storage or SAN a common value is assigned. Thus, members of couples (host1 and host2), (storage1 and storage2) and (SAN1 and SAN2) may be designated as interchangeable, with respect to the above coverage requirements. As such, the test plan's size may be reduced to cover one pair from each of the 32 groups of pairs shown in FIG. 2B.

Further, in the test plan the pairs of hosts, pairs of storages, and pairs of SANs are to be covered without regard to the internal order of values. Therefore, the internal order of couples (host1 and host2), (storage1 and storage2), and (SAN1 and SAN2) may be designated as interchangeable, in the context of the above coverage requirements. Accordingly, the test plan may be further reduced to cover one pair from each of the six groups of pairs shown in FIG. 2C.

In one implementation, designated or candidate interchangeable elements may be used by a coverage holes report. A coverage holes report refers to a reported analysis that computes the valid value combinations that are missing from a given set of tests (e.g., a set of value assignments to all variables) or coverage tasks. The analysis may be configured to consider interchangeable elements in a similar manner as that disclosed earlier with respect to application of a combinatorial algorithm to a test plan with designated interchangeable elements.

In other words, the analysis is performed with the understanding that the test plan is to cover one of the interchangeable elements in each equivalent class. Thus, if one of the interchangeable elements of an equivalent class appears in the given set of tests, then other interchangeable elements of that class are also considered covered. Said interchangeable elements, therefore, are no longer included in the result of the hole analysis, even if said elements did not actually appear in the given set of tests. If interchangeable elements exist in the system described by the model, then considering such elements in the holes analysis reports results in a more accurate report of the coverage gaps.

It is noteworthy that the above disclosed scenarios, methods, implementations and embodiments are provided by way of example. Thus, depending on implementation, optional variables and functions may be utilized to address alternative objectives in configuring a test space. As such, the above examples, embodiments and implementations should not be construed as limiting the scope of the claimed subject matter to the disclosed example scenarios or details.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

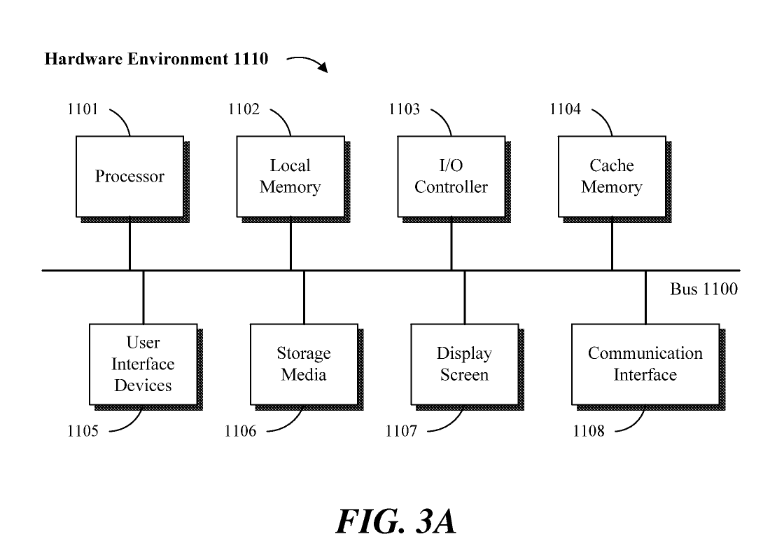

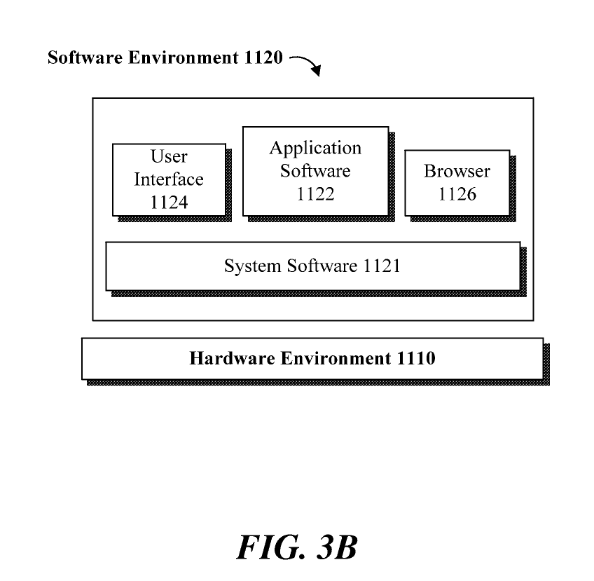

Referring to FIGS. 3A and 3B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3A, the application software and logic code disclosed herein may be implemented in the form of computer readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other computer-usable or computer readable media. Within the context of this disclosure, a computer usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a computer-usable or computer readable storage medium that provides program code for use by, or in connection with, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method executed on a processor for modeling a test space for verifying system behavior, the method comprising:
defining a coverage model based on:
one or more variables, wherein respective values for the variables are assigned to define a test space for a system under test, and
zero or more constraints defining restrictions on value combinations assigned to the variables, wherein the restrictions define whether said value combinations are valid; and
designating, as interchangeable, relevant combinations of variable values in the coverage model.

2. The method of claim 1 further comprising generating a set of tests based on valid value combination for the one or more variables, wherein the valid value combinations satisfy the one or more constraints taking into account the interchangeable variable values.

3. The method of claim 2 further comprising applying an algorithm to the set of valid value combinations for the variables that satisfy the restrictions to narrow the test space to a subset of the test space that includes a set of valid value combinations that satisfy the one or more constraints.

4. The method of claim 3, wherein the algorithm is applied to the subset of the test space that is implemented based on a designated interaction level, such that the designated interaction level defines coverage for the subset of the test space.

5. The method of claim 4 wherein the test space covers the possible combinations of m number of variables in the set defined by the coverage model, wherein m is less than or equal to the total number of variables n in the model.

6. The method of claim 3 wherein the algorithm is a combinatorial algorithm applied to the subset of the test space that is defined by multiple designated interaction levels.

7. The method of claim 6 wherein a first interaction level designates the interaction level for a first subset of the variables.

8. The method of claim 7 wherein a second interaction level designates the interaction level for a second subset of the variables.

9. The method of claim 1 further comprising applying an analysis to a given test suite to determine valid value combinations that are missing from the test space defined by the coverage model.

10. The method of claim 9 wherein the analysis is configured to consider the interchangeable values as defined in equivalent classes in the test space, so that tests in the test space that cover the interchangeable values are not reported as missing.

11. A system including one or more processors for modeling test space for verifying system behavior, the system further comprising:
a logic unit for defining a coverage model based on:
one or more variables, wherein respective values for the variables are assigned to define a test space for a system under test, and
zero or more constraints defining restrictions on value combinations assigned to the variables, wherein the restrictions define whether said value combinations are valid; and
a logic unit for designating, as interchangeable, relevant variables values in the coverage model.

12. The system of claim 11 further comprising generating a set of tests based on valid value combination for the one or more variables, wherein the valid value combinations satisfy the one or more constraints taking into account the interchangeable variable values.

13. The system of claim 12 further comprising applying an algorithm to the set of valid value combinations for the variables that satisfy the restrictions to narrow the test space to a subset of the test space that includes a set of valid value combinations that satisfy the one or more constraints.

14. The system of claim 13, wherein the algorithm is applied to the subset of the test space that is implemented based on a designated interaction level, such that the designated interaction level defines coverage for the subset of the test space.

15. The system of claim 11 further comprising applying an analysis to a given test suite to determine valid value combinations that are missing from the test space defined by the coverage model.

16. A computer program product including program code embedded in a non-transitory data storage medium, wherein execution of the program code on a processor causes a computer to:
define a coverage model based on:
one or more variables, wherein respective values for the variables are assigned to define a test space for a system under test, and
zero or more constraints defining restrictions on value combinations assigned to the variables, wherein the restrictions define whether said value combinations are valid; and
designate, as interchangeable, relevant variables values in the coverage model.

17. The computer program product of claim 16 further comprising generating a set of tests based on valid value combination for the one or more variables, wherein the valid value combinations satisfy the one or more constraints taking into account the interchangeable variable values.

18. The computer program product of claim 17 further comprising applying an algorithm to the set of valid value combinations for the variables that satisfy the restrictions to narrow the test space to a subset of the test space that includes a set of valid value combinations that satisfy the one or more constraints.

19. The computer program product of claim 18, wherein the algorithm is applied to the subset of the test space that is implemented based on a designated interaction level, such that the designated interaction level defines coverage for the subset of the test space.

20. The computer program product of claim 16 further comprising applying an analysis to a given test suite to determine valid value combinations that are missing from the test space defined by the coverage model.

21. A method executed on a processor for modeling a test space for verifying system behavior, the method comprising:
defining a coverage model based on:
one or more variables, wherein respective values for the variables are assigned to define a test space for a system under test, and
zero or more constraints defining restrictions on value combinations assigned to the variables, wherein the restrictions define whether said value combinations are valid; and
designating, as interchangeable, two or more variable values in the coverage model;
generating a set of tests based on valid value combination for the one or more variables, wherein the valid value combinations satisfy the one or more constraints taking into account the interchangeable variable values.

22. The method of claim 21 wherein the set of tests is generated to augments an existing set of tests to reach 100% coverage of designated interaction levels that define coverage for the subset of the test space.

23. The method of claim 21 wherein the generated set of tests is selected from a previously generated set of tests, wherein designated interaction levels covered by the previously generated set of tests are preserved by the generated set of tests selected from the previously generated set of tests.

24. The method of claim 21 wherein the set of tests are randomly generated.

25. The method of claim 21 further comprising automatically suggesting candidates for interchangeable variable values by detecting pairs of variables, wherein assignment of values to the variables does not change validity of the valid value combinations.
